(19) United States
(12) Patent Application Publication
(10) Pub. No.: US 2015/0090689 A1
(43) Pub. Date: Apr. 2, 2015

(54) COMPOSITIONS FOR PROTECTING DISPLAY GLASS AND METHODS OF USE THEREOF

(71) Applicant: Corning Incorporated, Corning, NY (US)

(72) Inventors: Diane Kimberlie Guilfoyle, Painted Post, NY (US); Hsien Li Lu, Taichung City (TW); Timothy Edward Myers, Painted Post, NY (US); Lu Zhang, Taipei (TW)

(21) Appl. No.: 14/493,470

(22) Filed: Sep. 23, 2014

Related U.S. Application Data
(60) Provisional application No. 61/883,265, filed on Sep. 27, 2013.

(51) Int. Cl. C09D 133/08; C03C 19/00; C03C 23/00; C03C 15/02; C09D 133/14; C03C 17/32

(52) U.S. Cl. CPC C09D 133/08; C09D 133/14; C03C 17/322; C03C 17/326; C03C 23/007; C03C 15/02; C03C 19/00
USPC 216/13; 522/25; 428/442; 427/154; 216/53

(57) ABSTRACT

Described herein are coating compositions for protecting one-glass solution (OGS) glasses and other display glasses during processing. The coatings are non-reactive to typical indium-tin oxide touch components, metal electrodes, and black matrix inks, and can thus be used to over-coat these materials. In one aspect, the coating compositions described herein can be applied by a screen printing application process in a single layer or in multiple layers and are compatible with CNC edge grinding and acid etching. Further, the protective coatings are rigid, but not brittle, and are durable but still able to be processed rapidly. Additionally, the protective coatings are transparent, allowing alignment marks on the substrates to be visible. Finally, the protective coatings can easily be removed after substrate processing has been completed.

### CROSS-REFERENCE TO RELATED APPLICATIONS

This application claims the benefit of priority under 35 U.S.C. §119 of U.S. Provisional Application Ser. No. 61/883,265 filed on Sep. 27, 2013 the contents of which are relied upon and incorporated herein by reference in their entirety.

### BACKGROUND

The makers of mobile phones, laptops, tablet computers, and other electronic devices are turning to glass, especially ion-exchange (IOX) strengthened glass, as the material of choice for the top cover pieces on these devices. The industry standard process has been to cut and finish glass into its final size, then process the glass via IOX. Following this, a touch panel built as a separate layer is attached to the cover glass. While this process makes a robust product, it requires many steps, which results in a relatively high cost. A recent industry trend has seen the cover glass and touch panel being integrated into one piece, a phenomenon known as the one-glass solution (OGS).

For cover glass with a built-in touch function, edge grinding is performed after the glass has been ion-exchanged and cut into near final shape. The edge grinding process gives the edges their final shape, but also introduces many flaws on the edges, rough transitions between the edges and the main surface, and chips on the surface. Further, the edge grinding process results in a low edge strength that is impractical for most, if not all, uses. To increase edge strength, the glass edges are typically etched with mineral acids. However, OGS glass typically includes easily-damaged components such as, for example, indium-tin oxide touch layers, metal electrodes, and decorative/black matrix inks, which have been incorporated prior to edge grinding. It is thus important to protect glass surfaces from damage that can occur during the edge grinding and/or acid etching processes.

Two strategies exist for protection of glass during edge grinding and acid etching: films and coatings. Films possess several disadvantages, the chief one being that they cannot be removed cleanly during edge grinding. Often, they tear or leave residue behind. This can lead to acid seepage through the edges, having values greater than or equal to 200 μm. Alternatively, coatings can be applied prior to edge grinding. For both films and coatings, typically, additional acid resistance films are required for adequate protection of glass surfaces during acid etching. This strategy suffers from drawbacks, namely that a coating can be applied to a large sheet of glass (i.e., before cutting), but films must be applied to individual pieces of glass (i.e., after cutting and edge grinding). In addition to complicating the production process, these additional steps can add significantly to the cost of producing OGS glass.

While some commercial coating materials are available, they are inadequate for protecting glass substrates throughout the entire OGS glass production process under conditions suitable for the mass production of electronic devices. What is needed is a coating that can be applied on a large sheet of glass before cutting, can meet the surface protection requirement for both edge grinding and acid etching, can withstand soaking in basic and/or acidic solutions while maintaining good surface adhesion through all processing steps, can be stripped with a benign solvent system without damaging the touch layer or black matrix inks, is screen printable, is easy to cure with minimal cycle times, is transparent to allow for recognition of alignment markings, and can easily release from the touch layer without causing damage. The present invention satisfies these requirements in a cost-effective manner.

### SUMMARY

Described herein are coating compositions for protecting one-glass solution (OGS) glasses and other display glasses during processing. The coatings are non-reactive to typical indium-tin oxide touch components, metal electrodes, and black matrix inks, and can thus be used to over-coat these materials. In one aspect, the coating compositions described herein can be applied by a screen printing application process in a single layer or in multiple layers and are compatible with CNC edge grinding and acid etching. Further, the protective coatings are rigid, but not brittle, and are durable but still able to be processed rapidly. Additionally, the protective coatings are transparent, allowing alignment marks on the substrates to be visible. Finally, the protective coatings can easily be removed after substrate processing has been completed.

The advantages of the invention will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below.

FIG. 1 shows a viscosity comparison of inks (coatings) with different inorganic filler contents.

FIG. 2 shows a typical viscosity curve for the surface protection coatings disclosed herein. Coating 1 contains talc as inorganic filler and coating 2 contains Aerosil R 7200 as inorganic filler.

FIG. 3 shows alignment marks on glass surfaces captured by a CCD camera. Panel (a) shows the un-coated glass substrate. Panel (b) shows coating 1 printed at 80 μm thickness. Panel (c) shows coating 2 printed at 80 μm thickness. The alignment mark is clearer for coating 2, which has a lower haze value.

FIG. 4 is a top view of a coating disclosed herein on a glass surface which has gone through an edge grinding process. The edge is clean without any coating residue, but the surface is well-protected by the coating. The coating near the edge is intact and displays no tearing.

FIG. 5 is a flow chart comparing the standard process for coating and adding acid resistance film (a) and the improved process using the coating compositions disclosed herein (b).

### DETAILED DESCRIPTION

Before the present compounds, compositions, articles, devices, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an inorganic filler” includes mixtures of two or more such inorganic fillers, and the like.

“Optional” or “optionally” means that the subsequently described event or circumstance can or cannot occur, and that the description includes instances where the event or circumstance occurs and instances where it does not. For example, the phrase “optionally includes an inorganic filler” means that the inorganic filler may or may not be present.

Ranges may be expressed herein as from “about” one particular value, and/or to “about” another particular value. When such a range is expressed, another aspect includes from the one particular value to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, “edge grinding process” refers to the process by which glass edges are ground into their final shape. “CNC” stands for computer numerical control and is one of several types of edge grinding processes used in industry; CNC processes are typically conducted after glass has been ion exchanged and cut into near-final shape. CNC edge grinding processes exhibit enhanced productivity due to extensive automation and the ability to run multiple grinding wheels simultaneously. However, CNC edge grinding processes can introduce flaws on edges, rough transitions between edges and surfaces, and chips on surfaces. Additionally, glass edge strength after a CNC process is often not high enough for practical usage. In one aspect, acid etching can be performed to improve edge strength of glasses ground by a CNC edge grinding process. In another aspect, the coatings disclosed herein can be applied to glass prior to CNC and acid etching to protect the glass surface from damage occurring during these processes. In this aspect, the coatings disclosed herein are fully compatible with the CNC process and are removed cleanly during the CNC process without leaving any residue on the glass surface or edge. In still another aspect, the glass ground using a CNC process may be used as cover glass with a built-in touch function.

As used herein, “indium tin oxide” (ITO) is a thin layer of a colorless, transparent solid solution of indium (III) oxide and tin (IV) oxide deposited on the surface of a piece of glass, such as, for example, a piece of glass to be used in a display or touch screen. ITO films can be deposited on surfaces by a physical vapor deposition technique such as electron beam evaporation or sputter deposition. ITO is an n-type semiconductor that is heavily doped. In one aspect, the conductive properties of ITO make it suitable for use as a touch-responsive layer in, for example, consumer electronics. In another aspect, ITO coats the surface of OGS glass prior to applying the coatings disclosed herein. In a further aspect, the coatings disclosed herein assist in protecting the ITO layer of OGS glass during the CNC and/or acid etching processes.

As used herein, “decorative ink”, also known as “black matrix ink” (BM), is a layer that is typically part of OGS glass. The BM ink or layer can optionally be part of a color filter in a glass display. Without wishing to be bound by theory, when present, the BM ink may function to prevent leakage of light between pixels; this may help to improve certain properties of the display, including contrast. In one aspect, the BM layer is created by wet-etch lithography. In another aspect, the BM layer is created by laser patterning.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed that while specific reference of each various individual and collective combination and permutation of these compounds may not be explicitly disclosed, each is specifically contemplated and described herein. For example, if an aliphatic urethane diacrylate is disclosed and discussed and a number of different compatible inorganic fillers are discussed, each and every combination and permutation of aliphatic urethane diacrylate and inorganic filler that is possible is specifically contemplated unless specifically indicated to the contrary. For example, if a class of molecules A, B, and C are disclosed as well as a class of molecules D, E, and F, and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F is specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, f a variety of additional steps can be performed, it is understood that each of these additional steps can be performed with any specific embodiment or combination of embodiments of the disclosed methods, and that each such combination is specifically contemplated and should be considered disclosed.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

### I. Coating Compositions and Preparation Thereof

Described herein are coating compositions for protecting display glass. In one aspect, the coating composition includes:

a. a partially acrylated epoxy monomer or oligomer;

b. an aliphatic urethane diacrylate;

c. an acrylate monomer; and

d. a polymerization initiator.

Each component is discussed in detail below.

a. Partially Acrylated Epoxy Monomer or Oligomer

In one aspect, the partially acrylated epoxy monomer or oligomer includes, but is not limited to, a partially acrylated bisphenol F epoxy resin, a partially acrylated epoxy novolac resin, a partially acrylated di- or polyglicidyl ether, or any combination thereof or with a partially acrylated bisphenol A epoxy resin. In another aspect, the partially acrylated epoxy monomer or oligomer is a partially acrylated epoxy bisphenol A. As used herein, a “partially acrylated epoxy bisphenol A” is a compound containing at least one bisphenol A moiety (4,4′-(propane-2,2-diyl)diphenol), as well as functional groups containing at least one acrylate and one epoxy functionality. In some aspects, the functional groups containing acrylate and/or epoxy functionalities are connected to the phenolic oxygens of bisphenol A, creating ether linkages. Suitable compounds of this class for use in the coatings disclosed herein include those sold under the trade name EBECRYL® (e.g., EBECRYL® 600, 605, 608, 3700, 3701, 3701-20T, 3708, 3720, 3720-HD20, 3720-TM20, 3720-TM40, 3720-TP25, 3720-TP40, 3605, and/or 3730-TP20) from UCB Radcure, Inc. (Smyrna, Ga.). In one aspect the partially acrylated bisphenol A is EBECRYL® 3605.

In one aspect, the partially acrylated epoxy monomer or oligomer is from 1% to 15% by weight of the coating composition. In another aspect, the partially acrylated epoxy monomer or oligomer is 1%, 2%, 3%, 4%, 5%, 6%, 7%, 8%, 9%, 10%, 11%, 12%, 13%, 14%, or 15% by weight of the coating composition, where any value can provide the basis of a lower and upper endpoint.

Without wishing to be bound by theory, the dual functionality of resins containing both acrylate and epoxy groups enables photoinitiated reactions to occur in the coatings disclosed herein when the coatings are exposed to UV radiation. In one aspect, UV curing results in a semi-cross-linked durable coating permitting immediate handling and/or additional processing, such as, for example, repeat applications of coating to build thickness, or rotation of the substrate to provide protection on both sides.

b. Acrylated Urethane

As used herein, “acrylated urethanes” are diacrylate esters of hydroxy-terminated isocyanate-extended polyesters or polyethers. In one aspect, the acrylated urethanes can be aliphatic. “Aliphatic” compounds are compounds composed of hydrogen and carbon that do not contain any aromatic rings. Aliphatic compounds can be saturated or unsaturated and can include alkanes, alkenes, and alkynes.

In another aspect, the acrylated urethanes can be aromatic. In one aspect, aliphatic acrylated urethanes are preferred because they are less susceptible to weathering. Examples of commercially-available acrylated urethanes include those known by the trade designations PHOTOMER (e.g., PHOTOMER 6010) (Henkel Corp., Hoboken, N.J.); EBECRYL 220 (hexafunctional aromatic urethane acrylate of molecular weight 1000), EBECRYL 284 (aliphatic urethane diacrylate of 1200 molecular weight diluted with 1,6-hexanediol diacrylate), EBECRYL 4827 (aromatic urethane diacrylate of 1600 molecular weight), EBECRYL 4830 (aliphatic urethane diacrylate of 1200 molecular weight diluted with tetraethylene glycol diacrylate), EBECRYL 6602 (trifunctional aromatic urethane acrylate of 1300 molecular weight diluted with trimethylolpropane ethoxy triacrylate), and EBECRYL 8402 (aliphatic urethane diacrylate of 1000 molecular weight) all from UCB Radcure Inc. (Smyrna, Ga.); SARTOMER (e.g., SARTOMER 9635, 9645, 9655, 963-B80, 966-A80) from Sartomer Co. (West Chester, Pa.); and UVITHANE (e.g., UVITHANE 782) from Morton International (Chicago, Ill.). Particularly useful acrylated urethanes include, for example, those available under the trade designations EBECRYL 270, EBECRYL 1290, EBECRYL 8301, and EBECRYL 8804, all from UCB Radcure Inc. (Smyrna, Ga.). In one aspect, the inclusion of an aliphatic urethane oligomer also yields a matte or low-gloss finish to the coated glass. In this aspect, low gloss prevents blocking (i.e., sticking together) of finished articles.

In one aspect, EBECRYL 270 is the aliphatic acrylated urethane. EBECRYL 270 is a UV-reactive aliphatic urethane diacrylate prepolymer based on an acrylated aliphatic isocyanate. Its weight average molecular weight is approximately 1500 and its viscosity is about 2700 centipoise at 60° C. As a film, it has good flexibility with a tensile strength of about 1000 psi and a tensile elongation of about 60%. It is also UV resistant, such that articles coated with a coating that includes EBECRYL 270 are lightfast. In another aspect, the aliphatic urethane diacrylate is from 10% to 50% by weight of the coating composition.

In one aspect, the acrylated urethane is from 10% to 50% by weight of the coating composition. In another aspect, the acrylated urethane is 10%, 15%, 20%, 25%, 30%, 35%, 40%, 45%, or 50% by weight of the coating composition, where any value can provide the basis of a lower and upper endpoint.

c. Diluent Monomer

As used herein, a “diluent monomer” is a chemical compound that possesses at least one reactive group and is capable of dissolving a compound with which it can chemically react. In one aspect, the diluent monomer is a liquid. In another aspect, the diluent monomer is capable of dissolving one or more oligomers or polymers. In still another aspect, the diluent monomer is isobornyl acrylate (IBOA). In this aspect, the cyclic group of IBOA produces polymers with high glass transition temperatures. In a further aspect, IBOA produces polymers through free radical curing. In another aspect, the diluent monomer is β-carboxyethyl acrylate, octyl/decyl acrylate, dipropylene glycol diacrylate, 1,6-hexanediol diacrylate, neopentyl glycol propoxylate diacrylate, tripropylene glycol diacrylate, acrylated dipenthaerythritol, propoxylated glycerol triacrylate, pentaerythritol tri-tetra-acrylate, trimethylolpropane ethoxy triacrylate, trimethylolpropane triacrylate, or a compound sold under the trade name EBECRYL® (e.g., EBECRYL® 113, 114, 1039, 130, 140, 180, 40, 53, 168, 160, or 150) manufactured by UCB Radcure, Inc. (Smyrna, Ga.).

In one aspect, the diluent monomer is from 10% to 50% by weight of the coating composition. In another aspect, the diluent monomer is 10%, 15%, 20%, 25%, 30%, 35%, 40%, 45%, or 50% by weight of the coating composition, where any value can provide the basis of a lower and upper endpoint.

d. Photoinitiator

A “photoinitiator” is a compound that undergoes a reaction upon absorbing light to produce reactive species. These compounds can then catalyze and/or initiate further reactions such as, for example, polymerization and/or curing reactions. Typically, these compounds can function under mild reaction conditions. In one aspect, the photoinitiator is a radical photoinitiator. In another aspect, the photoinitiator is a cationic photoinitiator. In still another aspect, a mixture of radical and cationic photoinitiators can be used. In one aspect, the photoinitiator is a compound sold under the trade name IRGACURE® (e.g., IRGACURE® 2022, IRGACURE® 127, IRGACURE® 184, IRGACURE® 184D, IRGACURE® 2100, IRGACURE® 250, IRGACURE® 270, IRGACURE® 2959, IRGACURE® 369, IRGACURE® 369 EG, IRGACURE® 379, IRGACURE® 500, IRGACURE® 651, IRGACURE® 754, IRGACURE® 784, IRGACURE® 819, IRGACURE® 819Dw, IRGACURE® 907, IRGACURE® 907 FF, or IRGACURE® Oxe01) from BASF (Ludwigshafen am Rhein, Germany). In another aspect, the photoinitiator is a compound sold under the trade name CD-1012 from Sartomer USA, LLC (Exton, Pa.). In another aspect, the photoinitiator is a compound sold under the trade name UVACURE® (e.g., 1500, 1600) from UCB Radcure Inc. (Smyrna, Ga.).

In one aspect the photoinitiator initiates curing by a free radical mechanism. In another aspect, the photoinitiator initiates curing by a Michael Addition mechanism. In a third aspect, the photoinitiator initiates curing by both free radical and Michael Addition mechanisms.

In one aspect, the photoinitiator is from 0.01% to 5% by weight of the coating composition. In another aspect, the photoinitiator is 0.01%, 0.05%, 0.1%, 0.5%, 1%, 2%, 3%, 4%, or 5% by weight of the coating composition, where any value can provide the basis of a lower and upper endpoint.

e. Inorganic Filler

In certain aspects, the coating compositions described herein can include one or more inorganic fillers. An “inorganic filler” is a substance that can be added to the present coating compositions to provide bulk and/or increase viscosity. In one aspect, the inorganic filler is non-reactive. In another aspect, the increase in viscosity provided by the inclusion of an inorganic filler can improve the screen printability of the coating compositions disclosed herein. In a further aspect, the screen printability is improved because dripping through the screen is eliminated due to the increase in viscosity provided by the presence of the inorganic filler. In one aspect, the inorganic filler can break bubbles generated during the screen printing process. In this aspect, bubbles generated during the screen printing process are undesirable because they are transferred to the printed coating; this generates pin holes in the coating and may allow acid seepage to occur. Thus, in this aspect, the inorganic filler may protect against acid seepage. In still another aspect, the use of an inorganic filler can result in an overall reduction in the cost of the materials needed to make the coating compositions disclosed herein.

In one aspect, the inorganic filler can be used in conjunction with a de-airing additive. In an alternative aspect, the inorganic filler can be used alone (i.e., with no de-airing additive). In another aspect, a de-airing additive negatively affects adhesion and is not used.

Various inorganic filler materials are contemplated. In one aspect, the inorganic filler can be a magnesium silicate or hydrated magnesium silicate mineral. In this aspect, the filler can be synthetic magnesium silicate, talc, or a combination thereof In one aspect, the talc can be a talc that is available under the trade names CERCRON® (e.g., CERCRON® MB 96-67), FLEXTALC® (e.g., FLEXTALC® 610), MICROTALC® (e.g., MICROTALC® BP-210), MICROTUFF® (e.g., MICROTUFF® 111), MV (e.g., MV 603), SERICRON® (e.g., SERICRON® 2M), TALCRON® (e.g., TALCRON® 45-26), or UltraTalc® (e.g., ULTRATALC® 609), all from Minerals Technologies (Barretts, Mont.).

In another aspect, the inorganic filler can be fumed or pyrogenic silica. In a further aspect, the inorganic filler can be a hydrophobic or hydrophilic fumed silica. Examples of commercially available fumed silicas include those known by the trade designations KONASIL K-90, KONASIL K-150, KONASIL K-200, KONASIL K-300, KONASIL K-121, and KONASIL K-122 from Keysu Industrial Col., Ltd. (Seoul, Korea); CAB-O-SIL HP-60, CAB-O-SIL M-5, CAB-O-SIL H-5, CAB-O-SIL HS-5, CAB-O-SIL EH-5, CAB-O-SIL TS-720, CAB-O-SIL TS-610, and CAB-O-SIL TS-530 from Cabot Corporation (Boston, Mass.); AEROSIL® R 972, AEROSIL® R 974, AEROSIL® R 104, AEROSIL® R 106, AEROSIL® R 202, AEROSIL® R 208, AEROSIL® R 805, AEROSIL® R 812, AEROSIL® R 812S, AEROSIL® R 816, AEROSIL® R 7200, AEROSIL® R 8200, AEROSIL® R 9200, AEROSIL® R 711, AEROSIL® R 927 Pharma, AEROSIL® 90, AEROSIL® 130, AEROSIL® 150, AEROSIL® 200, AEROSIL® 255, AEROSIL® 300, AEROSIL® 380, AEROSIL® OX 50, AEROSIL® TT 600, AEROSIL® 200 F, AEROSIL® 380 F, AEROSIL® 200 Pharma, AEROSIL® 300 Pharma, AEROPERL® 300/30, and AEROPERL® 300 Pharma from Evonik Industries AG (Essen, Germany), and combinations thereof In a still further aspect, the inorganic filler can be a mixture of one or more magnesium silicates and/or hydrated magnesium silicates with one or more fumed silicas.

In one aspect, the inorganic filler can be present in the coating composition up to 60% by weight of the composition. In another aspect, the inorganic filler is 5%, 10%, 15%, 20%, 25%, 30%, 35%, 40%, 45%, 50%, 55%, or 60% by weight of the coating composition, where any value can provide the basis of a lower and upper endpoint. In this aspect, inclusion of a higher amount of inorganic filler can reduce the cost of producing the coatings disclosed herein.

f. Preparation of Coating Compositions

The coating compositions described herein can be prepared using techniques known in the art. In one aspect, the partially acrylated epoxy monomer or oligomer is admixed with the acrylated urethane and diluent monomer. In certain aspects, the acrylated urethane and diluent monomer are commercially-available as a mixture (e.g., EBECRYL 270). The components can be admixed at room temperature using techniques known in the art. One or more optional inorganic fillers can be added to the mixture as needed. One or more photoinitiators are added to the mixture. In one aspect, the photoinitiator is added to the mixture above just prior to polymerization.

### II. Application of Coating Compositions

Once the coating composition has been prepared, it is applied to at least one surface of the display glass, and the coating composition is subsequently cured to produce the protective coating on the surface of the display glass.

In one aspect, the display glass is ion exchanged glass (IOX). “Ion exchanged” (IOX) glass has been chemically strengthened through a process by which, after the glass has been cut to its final size, it is soaked in a bath of molten salt. Smaller ions such as, for example, sodium, diffuse out of the glass while larger potassium ions from the molten salt replace them. When the glass cools, the larger potassium ions create a layer of compressive stress on the surface of the glass. In one aspect, ion exchanged glass is more resistant to damage. In one aspect, IOX glass is commonly used as the top cover piece on consumer electronic devices such as mobile phones, laptops, and tablet computers. In a further aspect, a touch panel is built separately on top of IOX glass. In this aspect, the touch panel may be a separate layer that is attached to the IOX glass, or may be integrated into one piece along with the IOX glass.

In another aspect, the display glass is one-glass solution (OSG). “One-glass solution” (OGS) as used herein refers to glass wherein cover glass and touch panel are integrated into one piece. In one aspect, OGS glass is produced using fewer process steps and at a reduced cost compared to producing cover glass and touch panels separately and later attaching them. In one aspect, the touch panel in OGS glass is composed of indium-tin oxide. In another aspect, the OGS glass is printed with black matrix and/or decorative ink and can also include one or more electrodes.

The coating compositions described herein can be applied to the surface of the display glass using techniques known in the art including, but not limited to, screen printing. “Screen printing” is a process by which ink and/or coatings can be deposited on a surface. In screen printing, coatings, ink, and/or like substances can be forced through a prepared mesh of fine material. Ideally, compositions to be screen printed have viscosity levels such that they do not drip through the screen prior to or during the printing process. In one aspect, the coatings disclosed herein are screen printable.

In one aspect, two layers of the coating composition are printed on each surface of the display glass. Without wishing to be bound by theory, two printings can eliminate pin holes that occur in thin, single coating layers. In another aspect, one layer of the coating composition can be printed on each surface of the display glass. In an alternative aspect, the coating composition has a thickness of 25 μm, 50 μm, 60 μm, 70 μm, 80 μm, 90 μm, 100 μm, 110 μm, or 125 μm, where any value can provide the basis of a lower and upper endpoint. In another aspect, the thickness of the coating composition is from 50 μm to 100 μm, 70 μm to 80 μm, or about 75 μm.

After the composition has been applied to the surface of the display glass, the coating composition is cured in order to produce the protective coating. In one aspect, the coatings described herein can be cured by exposure to UV light. In another aspect, the coatings can be cured by exposure to heat. In a third aspect, the coatings are cured by a combination of UV exposure and heat. A “photo-initiated hybrid coating composition” is a composition for which curing is initiated by UV light exposure and properties are optimized via a short heating step at the end of the curing process. In one aspect, the curing of a photo-initiated hybrid coating composition can be accomplished in-line on existing machinery. In this aspect, UV curing can be initiated with radiation of 3,000 to 6,000 mJ/cm², or about 5,000 mJ/cm². In another aspect, the heating step is carried out after the UV irradiation step. In a further aspect, heating is conducted for from about 1 minute to 60 minutes, or about 15 minutes to about 30 minutes at a temperature from 100° C. to 200° C., or about 150° C.

In one aspect, after curing the protective coating has a thickness of 25 μm, 50 μm, 60 μm, 70 μm, 80 μm, 90 μm, 100 μm, 110 μm, or 125 μm, where any value can provide the basis of a lower and upper endpoint. In another aspect, the thickness of the protective coating is from 50 μm to 100 μm, 70 μm to 80 μm, or about 75 μm.

In one aspect, no volatile organic compounds are generated during UV curing and/or UV/thermal hybrid curing. In this aspect, the negative environmental impacts of using solvent-based coatings are avoided. For example, waste is reduced, mechanical exhausts are not needed, and government permits are not required. In another aspect, UV curing reduces curing time. In this aspect, curing can take one minute or less to complete.

The coating compositions disclosed herein provide several advantages over previously-described coating compositions. In one aspect, the coatings are compatible with screen printing, which allows the use of existing equipment. In this aspect, the coated area can be patterned if necessary. In another aspect, the coatings are UV curable. In this aspect, curing can be an in-line process with a short cycle time, which can increase throughput. Further in this aspect, the coating is robust under normal handling conditions. In a further aspect, the adhesion of the coating to glass surfaces can be tuned with thermal curing. In this aspect, following UV curing, the coating is taken through a heating step to increase adhesion to the surface glass. In a further aspect, longer thermal treatment time results in better adhesion and less acid seepage. In another aspect, the coating after UV curing is fully compatible with thermal curing. In this aspect, the coating is dry and robust for handling and will not deform under normal thermal curing conditions.

The protective coatings described herein also possess several beneficial physical properties. In one aspect, the protective coatings have a high modulus. “Modulus” (also known as Young's modulus) is used to characterize materials including, but not limited to, glass. Modulus is a measure of stiffness. In one aspect, the coatings disclosed herein have high modulus values and stable properties and are hard and/or stiff. In another aspect, the high modulus values of the coatings disclosed herein allow the glass to which the coatings are applied to be scored and broken without peeling or delamination of the coatings.

In another aspect, the protective coatings disclosed herein have high hardness values. As used herein, “hardness” is the ability of a material to resist being scratched by another material.

In one aspect, the protective coatings described herein have high transmission values (i.e., they allow a large amount of light to pass through). “Transmission” describes the passage of visible light (i.e., light having a wavelength in the 390-700 nm portion of the spectrum) through a material. Transmission values are typically listed as percentages of the original radiation directed at the material. In one aspect, the coatings disclosed herein have high transmission values. In a further aspect, the transmission of the coatings disclosed herein can be about 85%, about 86%, about 87%, about 88%, about 89%, about 90%, about 91%, about 92%, about 93%, about 94%, or about 95%, when the coating is approximately 75 μm thick. In another aspect, transmission values can vary with the thickness of the coatings disclosed herein. In one aspect, high transmission values can allow recognition of alignment marks on the glass surface when viewed through the coatings disclosed herein.

In one aspect, the haze values of the coatings disclosed herein are low. “Haze,” as used herein, is a cloudy appearance of a substance. Haze is caused when light is scattered by factors such as, for example, particulate matter, contaminants, and/or surface imperfections. Haze is typically listed as a percentage of light diffusely scattered to percentage of light transmitted through a sample. In another aspect, the haze values of the coatings described herein can be about 40%, about 45%, about 50%, about 55%, about 60%, about 65%, about 70%, about 75%, about 80%, about 85%, about 90%, or about 95%. In one aspect, the haze is 97% when the coating thickness is about 75 μm. In another aspect, the haze is 45% when the coating thickness is about 75 μm. In a further aspect, haze values can vary with the thickness of the coatings disclosed herein.

In another aspect, the protective coatings have low acid seepage. As used herein, “acid seepage” refers to damage to the edges of glasses and/or the coatings that cover them after exposure to acid. In one aspect, acid seepage is measured in units of length such as, for example μm. In another aspect, acid seepage can vary according to the thickness of the coatings. In another aspect, acid seepage at different edge locations of the same sample can also vary within the sample. Acid seepage is assessed after a period of time during which the glasses with attached coatings are soaked in acid, such as, for example, 15 minutes or 30 minutes. In a further aspect, the acid used to assess acid seepage is HCl. In another aspect, the acid used to assess acid seepage is HF. In still another aspect, the acid used to assess acid seepage is a combination of HCl and HF. In this aspect, the concentrations of the acids can be 1.8M for HCl and 4.37M for HF. In one aspect, low acid seepage is desirable. In a further aspect, using a thicker coating can result in a lower acid seepage value. In this aspect, a coating thickness of about 50 μm, about 55 μm, about 60 μm, about 65 μm, about 70 μm, about 75 μm, or about 80 μm can reduce acid seepage values to acceptable levels.

In one aspect, the protective coatings disclosed herein can protect the glass surface through both CNC edge grinding and acid etching processes. “Acid etching” as used herein is a process designed to improve edge strength of glass that has been processed using CNC edge grinding. In one aspect, the edge strength of CNC edge ground glass is only about 200 MPa after edge grinding. In this aspect, acid etching can improve edge strength to as much as 500 MPa or higher. In one aspect, acid etching is performed with acids such as, for example, HF, HCl, and/or other mineral acids. In still another aspect, the acid used to perform acid etching is a combination of HCl and HF. In this aspect, the concentrations of the acids can be 1.8M for HCl and 4.37M for HF. In one aspect, CNC edge grinding is performed, then an acid-resistance film is applied to the glass prior to acid etching.

“Wet adhesion” is evaluated by performing the scratch test, the glass s/b with coating test, and the cross hatch test after soaking the coated glass in a heated alkaline solution. In one aspect, the coated glass can be soaked for 10 min, 20 min, 30 min, 40 min, 50 min, 60 min, 90 min, or 120 min. In another aspect, the coated glass can be heated at 30° C., 35° C., 40° C., 45° C., 50° C., 55° C., 60° C., 65° C., 70° C., 75° C., 80° C., 85° C., 90° C., or 95° C. In still another aspect, the pH of the soaking solution can be about 7.5, about 8, about 8.5, about 9, about 9.5, about 10, about 10.5, about 11, about 11.5, about 12, about 12.5, about 13, or about 13.5. In a further aspect, the soaking solution can be a Blue Kool solution. In one aspect, the coated glass is soaked for about 60 min at about 50° C. in a solution having pH 9.0 prior to performance of the wet adhesion test. “Dry adhesion” is evaluated by performing the scratch test, the glass s/b with coating test, and the cross hatch test after curing (i.e., when the coating is dry).

The coating compositions described herein provide an efficient way to protect and produce display glass with minimal defects. In one aspect, a method for preparing a display glass is provided. In this aspect, the following steps are performed: (1) a coating composition disclosed herein is applied to the surface of the display glass, (2) the coating composition is cured to produce a protective coating, (3) the display glass is cut to the desired shape and size, (4) the edges of the display glass are ground into the final shape and size, (5) the edges of the display glass are acid etched, and (6) the protective coating is removed from the display glass. In another aspect, any of the following steps can optionally be performed: (a) processing the glass using an ion-exchange process, (b) applying a touch layer, (c) applying one or more metal electrodes, (d) applying decorative or black matrix inks to the display glass.

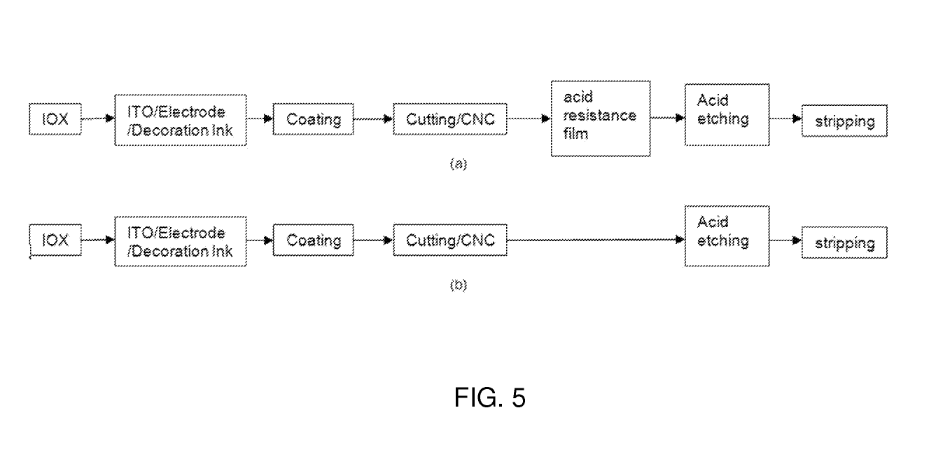

This process described above is depicted in FIG. 5b. Here, an acid resistant film is not applied or used as in previous techniques (FIG. 5a). Acid resistant films cannot be removed cleanly during edge grinding and can tear or leave residue. In another aspect, the poor performance of films during edge grinding can result in acid damage to glass surfaces during acid etching steps. In this aspect, a second film with acid-resistance properties (FIG. 5a) can be applied after edge grinding. However, the film has to be applied to individual pieces of glass (i.e., glass cannot be cut after film has been applied). The protective coatings disclosed herein can reduce the material and process costs and eliminates one or more steps from the processes currently in use in industry (FIG. 5a).

As discussed above, the coating compositions possess several advantageous properties. The protective coatings described herein are fully compatible with a CNC edge grinding process. In this aspect, the coatings have high modulus and hardness values; these enable the coating to be removed cleanly during the CNC process without leaving any residue on the surface or edge of the glass. In one aspect, the coating is fully compatible with acid etching and the use of the coating results in low acid seepage values. In another aspect, the coating exhibits good light transmission and/or low haze. The transmission and haze values can, in this aspect, allow for the recognition of alignment marks on the glass surface when viewed through the coating.

Another advantage of the protective coating described herein is that they can be easily removed after CNC grinding and acid etching. In one aspect, the coated glasses can be soaked in an organic solvent such as, for example, N-methylpyrrolidinone (NMP) solutions. In a further aspect, the NMP solutions can be heated to from about 30° C. to about 100° C., or from about 50° C. to about 70° C., or to about 60° C. In another aspect, the NMP solutions can also be sonicated. In yet another aspect, the coating can be removed in from about 10 minutes to about 30 minutes, or from about 15 minutes to about 25 minutes, or in about 20 minutes. In yet another aspect, the coatings detach from the glass surface rather than dissolving. In this aspect, the NMP solutions thus can be re-used, resulting in lower total cost and lower production of chemical waste.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. Numerous variations and combinations of reaction conditions, e.g., component concentrations, desired solvents, solvent mixtures, temperatures, pressures, and other reaction ranges and conditions can be used to optimize the product purity and yield obtained from the described process. Only reasonable and routine experimentation will be required to optimize such processes and conditions.

The “scratch test” is a method for assessing the adhesion of a coating to a glass substrate. In this test, an X shape is cut into the coating. If the area outlining the X pops up from the substrate, the coating fails the scratch test. In one aspect, the X shape that is cut into the coating is approximately 1 to 2 inches high.

The “glass s/b with coating” test is another method for assessing the adhesion of a coating to a glass substrate. In this test, a coated glass substrate is scored with a glass cutting tool, then the glass is broken along the score line. If the coating breaks cleanly with the glass, it passes the “glass s/b with coating” test. If the coating tears, does not break, or peels off, it fails this test.

A “cross hatch” test is a quantitative test (ASTM D3359-09) that measures adhesion of coating to a substrate by tape test. In one aspect, Intertape LA-26 polyester/rope fiber laminate tape can be used. A 5B result on this test is indicative of 100% coating adhesion under test conditions.

In one aspect, the scratch test, the glass s/b with coating test, and the cross hatch test are each performed twice. In one aspect, the tests are first performed prior to a treatment. In another aspect, the tests are also performed following that same treatment.

### Example 1

### Coating Compositions

Table 1 shows coating compositions prepared according to the present claims.

TABLE 1
Surface Coating Compositions

| Component | Amount (wt %) |
|---|---|
| Ebecryl 3605 | 2.00-12.80 |
| Ebecryl 270 | 15.0-43.37 |
| Isobornyl Acrylate (IBOA) | 15.0-46.30 |
| Irgacure 2022 | 0.05-1.74 |
| CD1012 | 0.05-0.76 |
| Talc 96-67 | 0.00-60.00 |
| Aerosil R 7200 | 0.00-40.00 |

The coatings are UV curable. Coatings were printed and cured in a continuous process. UV irradiation was supplied by a Fusion 300 W unit, D bulb, with a belt speed of 4.5 or 5 ft/min; UV intensity was 5000 mJ/cm² as measured by an IL Radiometer 390. In some instances, 15-30 minutes of thermal curing at 150° C. was applied after the final UV curing step to enhance the coating adhesion.

### Example 2

### Filler Materials for Coating Compositions

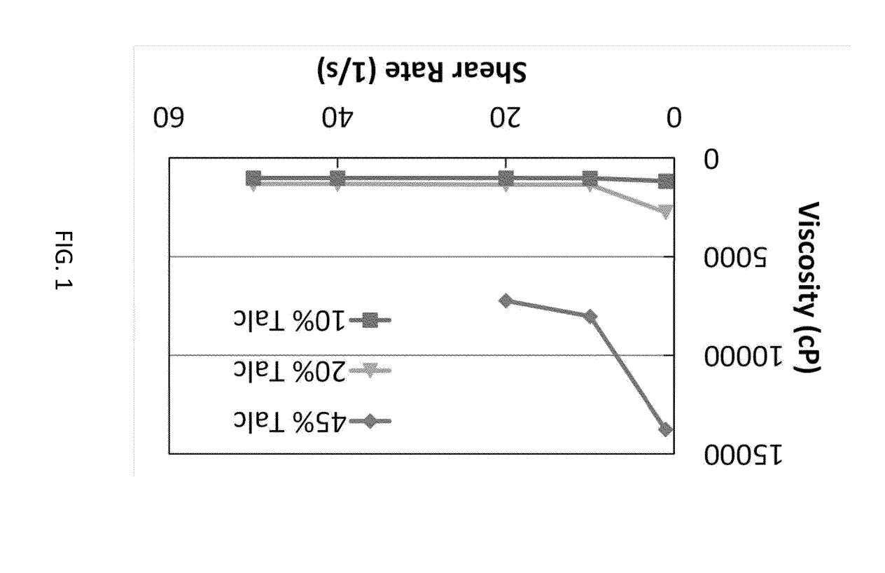

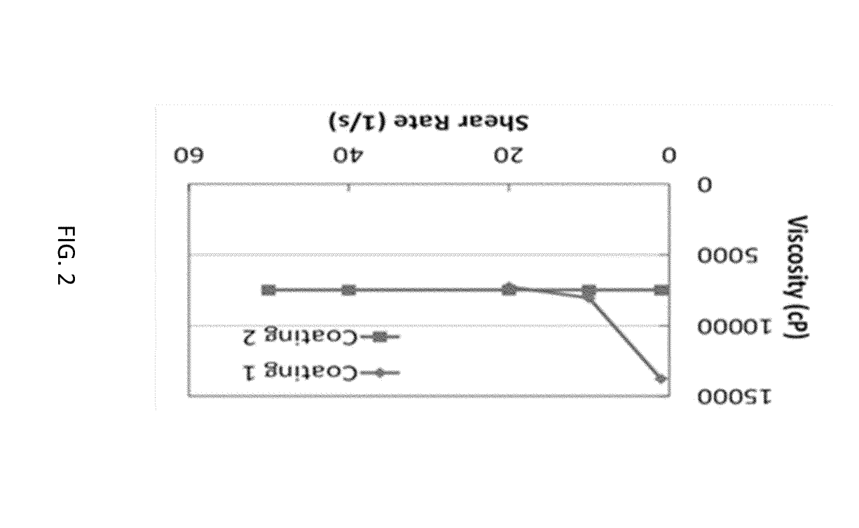

For some coating compositions, talc was used as a filler to improve screen printability by preventing or reducing dripping of ink (coating) through the screen during the screen printing process. For other coating compositions, fumed silica (as Aerosil R 7200) was used as a filler. Ink with 10 or 20% talc still suffered from the dripping problem, but using higher amounts of inorganic filler eliminated this problem. FIG. 1 shows viscosity values (as shear rates) for inks with 10%, 20%, and 45% talc. FIG. 2 shows typical viscosity curves for coatings with optimal compositions; coating 1 contains talc as an inorganic filler and coating 2 contains Aerosil R 7200.

### Example 3

### Haze of Coating Compositions

The addition of filler slightly reduces transmission but increases haze, as shown in Table 2. The haze of un-coated glass is typically less than 1%.

TABLE 2
Haze and Transmission Values

| Sample | Thickness | Transmission % | Haze % |
|---|---|---|---|
| Coating 1 | ~75 μm | 87 | 97 |
| Coating 2 | ~75 μm | 94 | 45 |

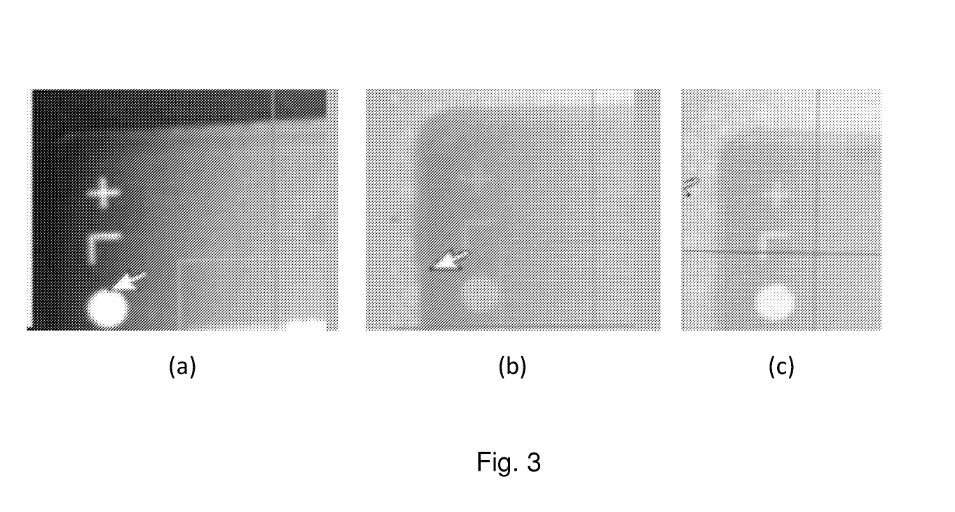

Alignment marks on glass samples must be recognizable by imaging capture systems (e.g., CCD cameras) after application of the coating to the glass surfaces. FIG. 3 shows a comparison of captured images of alignment marks for un-coated (photo a) and coated (photos b and c) glass samples. While the alignment marks are less clear when samples have been coated, images of the marks were still able to be captured and recognized by a CCD camera. A clearer image was captured with a coating having a lower haze value.

### Example 4

### Properties of the Coatings

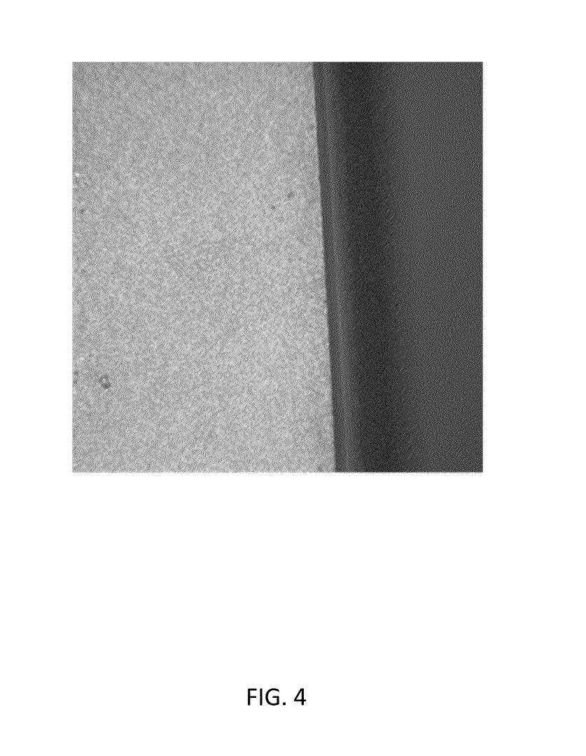

The coatings were formulated to have high modulus values to allow clean removal of the coating edges during the edge grinding process (CNC) for the glass substrate itself Additionally, the coatings were not so brittle as to chip during the edge grinding process. FIG. 4 shows the edge and surface of the coating after the edge grinding process (CNC). The coating was successfully removed from the edge without any residue left behind; further, the coating at and near the edge was not damaged during the edge grinding process.

For some CNC processes, the coolant used had an elevated pH value (approximately 9). The coatings described herein were compatible with this process and did not degrade in basic solution.

Three different tests were performed on the coatings described herein and on several commercially-available coatings for the purposes of comparison. In the “scratch test” an X approximately 1 to 2 inches high is cut into the coating. If the area outlining the X pops up, the coating fails the scratch test. In the “glass s/b with coating” test, the coated substrate is scored with a glass cutting tool, then the glass is broken along the score line. If the coating breaks cleanly with the glass, it passes; if the coating tears, does not break, or peels off, it fails. Finally, a quantitative “cross hatch” test was performed; this test is also known as ASTM D3359-09 and involves measuring adhesion of coating to substrate by tape test using Intertape LA-26 polyester/rope fiber laminate tape. A 5B result of this test indicated 100% adhesion.

All three tests were performed immediately after curing (initial “dry adhesion”) and repeated after soaking for 60 min in a heated (50° C.) alkaline (Blue Kool) solution having pH 9.0 (“wet adhesion”). Results of adhesion tests are provided in Table 3.

TABLE 3
Adhesion Test Results for Coatings

| | | | Commercial UV-Curable Materials | | |
|---|---|---|---|---|---|
| | | Present | (75 μm thickness) | | |
| | | Coating | Speedmask | 3M | Temploc |
| | | (75 μm) | 728G | 2700 C | N 102 |
| Dry | scratch test | pass | pass | fail | pass |
| Adhesion | glass s/b | clean | clean | tears | clean |
| | with coating | | | | |
| | cross hatch | 5B | 5B | 4B | 5B |
| Wet | scratch test | pass | fail | fail | fail |
| Adhesion | glass s/b | clean | tears | floats | tears |
| | with coating | | | off | |
| | cross hatch | 5B | 0B | 0B | 2B |

Coatings that passed both sets of tests with at least a result of 5B were replicated on substrates and passed through a standard CNC cycle.

### Example 5

### Acid Resistance of the Coatings

After being subjected to a CNC cycle, coatings on substrates were immersed for 15 or 30 min in an HF/HCl acid solution at approximately room temperature; the HF concentration was 4.37 M and the HCl concentration was 1.8 M. Samples remained stationary in solution. After the acid soaking, the samples were rinsed and the coating stripped off to inspect the acid damage on the surface and the acid seepage along the edges.

With one printing (screen printing, about 30-40 μm thickness), some small pin holes in the coating led to localized surface etching. With double printing, the pin holes could be eliminated. Table 4 shows acid seepage along the edges of the coatings after acid etching.

TABLE 4
Acid Seepage Values of Coatings (μm)

| Acid | Coating | Coating | | |
|---|---|---|---|---|
| etching | (50 μm | (75 μm | | External |
| time (min) | thickness) | thickness) | Film | Coating |
| 15 | 107 | 92 | 170 | 175 |
| 30 | 144 | 134 | 224 | 195 |

Acid seepage with commercial films and external coatings was higher in all cases than acid seepage with the coatings described herein. For the coatings described herein, slightly less acid seepage was observed for a thicker coating than for a thinner coating.

### Example 6

### Removal of the Coatings

Neutral (i.e., pH 7) solutions were used for coating stripping. Coated samples were soaked in N-methylpyrrolidinone (NMP) solutions; in some cases, the solutions were heated to 60° C. and/or sonicated. Coating removal required approximately 20 min to complete. The NMP solutions did not damage other surface coatings of the glass substrates (e.g., indium tin oxide, electrode, decorative ink). The NMP solutions could be re-used as the coatings detached from the glass substrates instead of dissolving.

Throughout this application, various publications are referenced. The disclosures of these publications in their entireties are hereby incorporated by reference into this application in order to more fully describe the compounds, compositions, and methods described herein.

Various modifications and variations can be made to the compounds, compositions, and methods described herein. Other aspects of the compounds, compositions, and methods described herein will be apparent from consideration of the specification and practice of the compounds, compositions, and methods disclosed herein. It is intended that the specification and examples be considered as exemplary.

What is claimed:

1. A display glass comprising a protective coating on at least one surface of the glass, wherein the protective coating is applied to the surface of the display by the method comprising:
a. applying to the surface of the display glass a coating composition comprising:
i. a partially acrylated epoxy monomer or oligomer;
ii. an acrylated urethane;
iii. a diluent monomer; and
iv. a photo initiator; and
b. curing the coating composition to produce the protective coating on the surface of the display glass.

2. The display glass of claim 1, wherein the partially acrylated epoxy monomer or oligomer comprises a partially acrylated bisphenol A epoxy resin; a partially acrylated bisphenol F epoxy resin; a partially acrylated epoxy novolac resin; a partially acrylated di- or polyglycidyl ether, or any combination thereof.

3. The display glass of claim 1, wherein the partially acrylated epoxy monomer or oligomer is a partially acrylated bisphenol A epoxy.

4. The display glass of claim 1, wherein the partially acrylated epoxy monomer or oligomer is from 1% to 15% by weight of the coating composition.

5. The display glass of claim 1, wherein the acrylated urethane is an aliphatic acrylated urethane, an aromatic acrylated urethane, or a combination thereof.

6. The display glass of claim 1, wherein the acrylated urethane is from 10% to 50% by weight of the coating composition.

7. The display glass of claim 1, wherein the diluent monomer comprises isobornyl acrylate, β-carboxyethyl acrylate, octyl/decyl acrylate, dipropylene glycol diacrylate, 1,6-hexanediol diacrylate, neopentyl glycol propoxylate diacrylate, tripropylene glycol diacrylate, acrylated dipenthaerythritol, propoxylated glycerol triacrylate, pentaerythritol tri-tetra-acrylate, trimethylolpropane ethoxy triacrylate, trimethylolpropane triacrylate, or any combination thereof.

8. The display glass of claim 1, wherein the diluent monomer is isobornyl acrylate.

9. The display glass of claim 1, wherein the diluent monomer is from 10% to 50% by weight of the coating composition.

10. The display glass of claim 1, wherein the photoinitiator comprises a free radical initiator, a cationic photoinitiator, or a combination thereof.

11. The display glass of claim 1, wherein the photoinitiator is from 0.01% to 5% by weight of the coating composition.

12. The display glass of claim 1, wherein the coating composition further comprises an inorganic filler.

13. The display glass of claim 12, wherein the filler comprises talc, silica, magnesium silicate or any combination thereof.

14. The display glass of claim 12, wherein the filler is up to 60% by weight of the coating composition.

15. The display glass of claim 1, wherein the coating composition is applied to the surface of the display glass by screen printing.

16. The display glass of claim 1, wherein step (b) comprises exposing the coating composition to UV light.

17. The display glass of claim 16, wherein the UV light is from 3,000 to 6,000 mJ/cm².

18. The display glass of claim 1, wherein step (b) comprises (1) exposing the coating composition to UV light followed by (2) heating the coating composition.

19. The display glass of claim 18, wherein the heating step is from 100° C. to 200° C. for 1 minute to 60 minutes.

20. The display glass of claim 1, wherein after step (b) the protective coating has a thickness of 25 to 125 μm.

21. The display glass of claim 1, wherein the display glass is ion exchanged glass or one-glass solution glass.

22. A method for applying a protective coating on at least one surface of a display glass, the method comprising:
a. applying to the surface of the display glass a coating composition comprising:
i. a partially acrylated epoxy monomer or oligomer;
ii. an acrylated urethane;
iii. a diluent monomer; and
iv. a photo initiator; and
b. curing the coating composition to produce the protective coating on the surface of the display glass.

23. The method of claim 22, wherein after step (b), removing the protective coating from the display glass.

24. The method of claim 23, wherein the protective coating is removed by dipping or soaking the coated display glass in an organic solvent.

25. The method of claim 24, wherein the organic solvent is N-methylpyrrolidinone.

26. The method of claim 24, wherein the solvent is heated at a temperature from 30 to 100° C.

27. The method of claim 23, wherein the protective coating is detached from the display glass.

28. A method for preparing a display glass, the method comprising
a. applying to the surface of the display glass a coating composition comprising:
i. a partially acrylated epoxy monomer or oligomer;
ii. an acrylated urethane;
iii. a diluent monomer; and
iv. a photo initiator;
b. curing the coating composition to produce the protective coating on the surface of the display glass;
c. cutting the display glass into a desired shape and size;
d. edge grinding the display glass into the final shape and size;
e. etching the edges of the display glass with an acid; and
f. removing the protective coating from the display glass.

29. The method of claim 28, wherein prior to step (a), (i) processing the display glass by an ion-exchange process and (ii) applying a touch layer, a metal electrode, and a decorative ink to the surface of the display glass.

30. The method of claim 28, wherein step (d) comprises a CNC edge grinding process.

31. The method of claim 28, wherein the acid comprises hydrofluoric acid.

32. A coating composition comprising:
a. a partially acrylated epoxy monomer or oligomer;
b. an acrylated urethane diacrylate;
c. a diluent monomer; and
d. a photoinitiator.
